(19) United States
(12) Patent Application Publication
(10) Pub. No.: US 2004/0064591 A1
(43) Pub. Date: Apr. 1, 2004

(54) Dynamic network configuration

(76) Inventor: Erwin Noble, San Jose, CA (US)

Correspondence Address: PHILIPS ELECTRONICS NORTH AMERICA CORPORATION, INTELLECTUAL PROPERTY & STANDARDS, 1109 MCKAY DRIVE, M/S-41SJ, SAN JOSE, CA, 95131, US

(21) Appl. No.: 10/261,248

(22) Filed: Sep. 30, 2002

(51) Int. Cl. G06F 15/16

(52) U.S. Cl. 709/250

(57) ABSTRACT

The information required to configure a device for each network that a device encounters is stored for subsequent retrieval. Thereafter, when the device re-encounters each network, this information is used to automate the configuration of the device to access the encountered network. To uniquely distinguish each network, the network identifier is created via a hierarchical process that combines the network's service set identifier (SSID), the Internet protocol (IP) address, and the access device's MAC address.

### BACKGROUND OF THE INVENTION

1. Field of the Invention

This invention relates to the field of computer communications, and in particular to a method and system for dynamically configuring a computer system for communication via alternative wireless networks.

2. Description of Related Art

To configure a computer to communicate within a particular network, a user initiates a configuration program and responds to prompts or selections offered by the configuration program. The user may be prompted to identify the protocol used by the network, the network name and/or “workgroup” name, the password required to enter the network, the user name or computer name that identifies the user, and so on. Depending upon the particular configuration program, and/or the particular network being accessed, and/or the technical expertise of the user, the configuration task may be a simple process or a technical challenge.

Conventional, the burden of configuring a computer to operate in a network is addressed by providing configuration programs, or “wizards” that are simpler to use, some being almost completely automatic. Whatever burden may remain is not deemed to be significant, because, typically, once a computer is tied into a network, it remains in that network, and subsequent configuration problems are not encountered.

With the continued proliferation of portable computer devices, a user of a portable device is likely to encounter multiple networks on a regular basis. The user may plug the portable device into a wired network in an office environment, then bring the device to a conference room and communicate with the same network via a wireless interface. While at the conference, other devices in the conference room may establish an ad-hoc network, and invite the user's device to participate. When the user travels, the device may be configured to access a local network at an airport, or to access a wired or wireless network on an aircraft to gain access to an Internet gateway. At home, the device may communicate with a home automation network, a multi-media control system, a custom-designed local area network, and so on. As the user travels from network to network, the user is generally required to reconfigure the portable device to participate in each network.

Conventionally, to ease the configuration tasks in a mobile environment, a user creates a utility program, or “macro”, that can be invoked for each network, and associates an icon with this program. When the user re-enters each network environment, the user determines the appropriate icon to click, and accesses the network. However, this solution is only available to a user who is technically able to create a utility program for each of the networks, and this solution still requires that the user initiate a configuration process as each network is encountered.

### BRIEF SUMMARY OF THE INVENTION

It is an object of this invention to provide a method and system that facilitates the configuration of a computer device for access to varied networks. It is a further object of this invention to provide a method and system that minimizes the user interactions required to access each network that a user regularly encounters. It is a further aspect of this invention to provide a method and system that stores configuration information as each new network is encountered, to facilitate subsequent re-connections.

These objects and others are achieved by providing a method and system that records the information required to configure a device for each network that the device encounters. Thereafter, when the device re-encounters each network, this information is used to automate the configuration of the device to access the encountered network. Each network that the device encounters is identified by a network identifier, and the configuration information is stored and indexed via this network identifier. To uniquely distinguish each network, the network identifier is created via a hierarchical process that combines the network's service set identifier (SSID) and the access device's Internet protocol (IP) address, and medium access control (MAC) address.

### BRIEF DESCRIPTION OF THE DRAWINGS

The invention is explained in further detail, and by way of example, with reference to the accompanying drawings wherein:

FIG. 1 illustrates an example multiple-network environment.

FIG. 2 illustrates an example block diagram of a processing system with dynamic network configuration in accordance with this invention.

FIG. 3 illustrates an example flow diagram of a dynamic network configuration system in accordance with this invention.

FIG. 4 illustrates an example flow diagram of a process for creating a substantially unique network identifier.

Throughout the drawings, the same reference numerals indicate similar or corresponding features or functions.

### DETAILED DESCRIPTION OF THE INVENTION

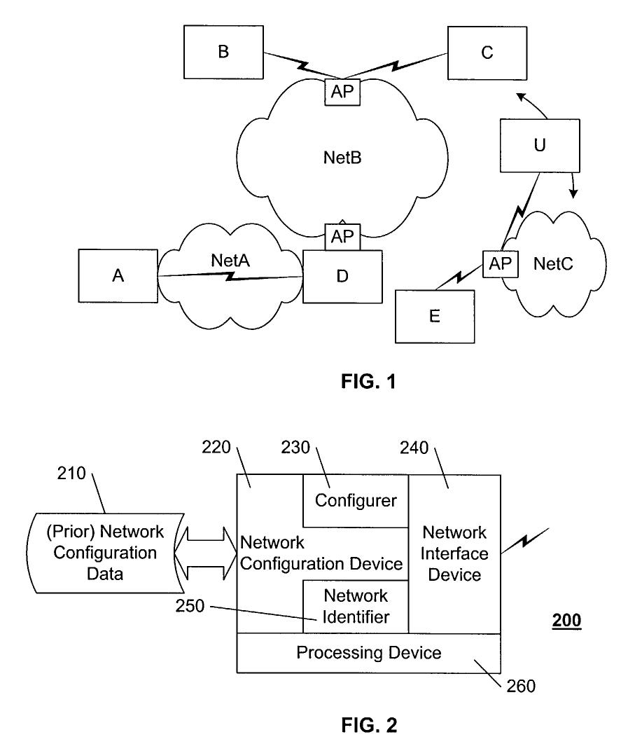

FIG. 1 illustrates an example environment that includes three networks, NetA, NetB, and NetC. Each of the networks NetB and NetC are conventional infrastructure nets that include one or more access points (AP) 101, 102, 103, through which one or more devices, or “stations” B, C, D, E, and U access the network. NetA, on the other hand, represents an ad-hoc network between stations A and D, without an explicit network access point.

Each of the access points 101, 102, 103 to each network NetB, NetC is a conventional network interface device, such as an Ethernet hub or a USB hub, that allow for wired or wireless communications, or both, to stations on the network, or a single-station network interface card (NIC) that provides direct wired access to the network.

As discussed above, when a user's station, such as station U in FIG. 1, traverses from network to network, the station must generally be configured to communicate with an access point of the subsequent network. This configuration will typically include both non-wireless and wireless parameters, such as:

Non-wireless parameters:

IP address and subnet mask, or, “automatic” via DHCP,

DNS settings, and

WINS settings.

Wireless parameters:

Network Name (SSID),

Network Type (Infrastructure or ad-hoc),

Transmit rate,

Encryption settings,

Channel sets (country specific),

Preferred AP if several are available, and so on.

In accordance with this invention, when the user station U first enters a network NetA, NetB, NetC, the parameters and other data that is required to configure the station for this network are stored for subsequent re-use. When the user station U again enters the network NetA, NetB, NetC, this stored configuration data is used to reconfigure the user station U to this next network.

FIG. 2 illustrates an example block diagram of a processing system 200 with dynamic network configuration in accordance with this invention. The system 200 includes a configurer that is provide to configure a network interface device 240 to facilitate the transfer of data between a processing device and a network, as discussed above. In accordance with this invention, a network configuration device 220, which may be a part of the processing device 260 or the network interface device 240, stores configuration data 210 that is used to configure the network interface device 230, for subsequent use if the same network is re-encountered.

As is known in the art, each network has an associated network identifier, or network name, that serves to identify the network to each station, regardless of the access point that is used to enter the network. However, conventional network identifiers, such as the SSID identifier that is used to identify IEEE 802.11 networks, are not necessarily unique, and often correspond to a common default identifier. As such, it is possible, and often likely, that a mobile user will encounter different networks having the same network identifier.

In accordance with this invention, the network identifier creates a substantially unique network identifier, to provide an index to the stored configuration data 210 for previously encountered networks. In a preferred embodiment, this substantially unique identifier corresponds to a combination of the conventional non-unique network identifier and select identifiers that are associated with the access device that is used to access the network. Specifically, in a preferred embodiment, the conventional SSID network identifier is combined with the IP-address of a device on the network, and/or with the MAC address of the access device. Any number of techniques may be used to effect the combination, including a simple concatenation of the SSID and the IP and/or MAC addresses. Optionally, a hashing function may be used to create an efficient index for storing and retrieving the configuration parameters based on the SSID and IP and/or MAC addresses.

Thereafter, when a network is encountered, the network configuration device 220 creates a unique identifier for this network, then checks the network configuration data 210 for a matching identifier. If a matching identifier is found, the network configuration device uses the stored configuration data 210 corresponding to this identifier to configure the system 200 for communications with the re-encountered network. If a matching identifier is not found, the network configuration device employs conventional techniques for configuring the system 200, as discussed above, and stores the configuration data for this newly encountered network, using the unique identifier of this network. In a preferred embodiment, the user of the system 200 is provided the option of adding comments, or associating other data, to the stored configuration data, to facilitate identification of the network, or to facilitate subsequent transactions, such as the invocation of routine processes, within the network.

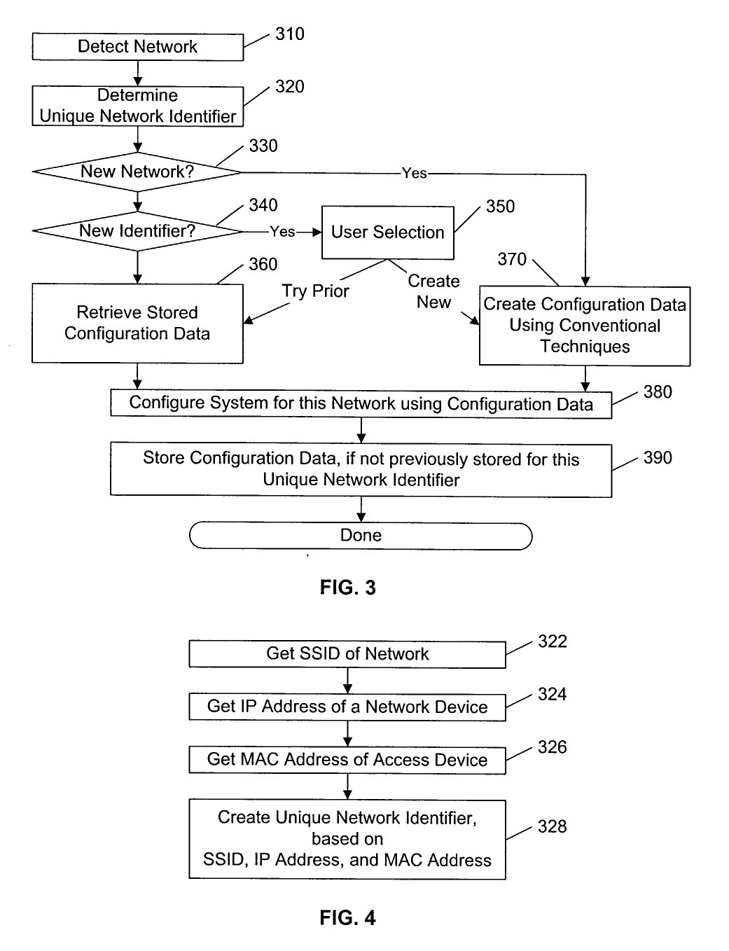

FIG. 3 illustrates an example flow diagram of a dynamic network configuration system in accordance with this invention. At 310, a network is detected by a network interface device. This may be accomplished by merely listening for network traffic, or by periodically transmitting a probe signal that causes an access point, or a peer device in a potential ad-hoc network, to respond. When the network is detected, a substantially unique identifier of the network is determined, at 320. In most conventional networks, this unique identifier must be created, as discussed further below with regard to FIG. 4.

If the network has not been encountered before, at 330, as determined by a conventional network identifier, such as the SSID of the network, the required configuration data is created/determined using conventional techniques, at 370. As discussed above, such techniques generally include prompting the user of the device for parameters such as a network-specific user identification, a password, and so on. In accordance with this invention, the parameters used to configure the network interface device are stored for subsequent retrieval. In a straightforward embodiment, for example, the configuration process may be recorded as an executable “macro”, for subsequent playback to re-effect the configuration.

If the network has been encountered before, at 330, but the unique network identifier has not been encountered before, at 340, the network interface device 220 is configured to prompt the user for guidance. The network configuration device 220 informs the user of the information that it has determined from the network, and presents the user with a list of prior-encountered networks having the same non-unique identifier (SSID) and any pertinent information about these prior encountered networks, such as the aforementioned user comments associated with the configuration data. From this information, the user may determine that the current network corresponds to a previously encountered network, and if so, may direct the network configuration device 220 to configure the system 200 using the configuration data of the previously encountered network, at 360. If the user does not recognize a similarity between the current network and a previously encountered network, the user may direct the network configuration device 220 to proceed with determining the appropriate configuration data using conventional techniques, at 370.

If the unique network identifier has been encountered before, at 340, the network configuration device 220 retrieves the corresponding configuration data 210, at 350.

At 360, the system 200 is configured to communicate via the current network, using the configuration data obtained from storage, at 360, or from conventional techniques, at 380. At 370, if the unique network identifier is new, the configuration data is stored for subsequent retrieval based on this unique network identifier.

FIG. 4 illustrates an example flow diagram of a process for creating a substantially unique network identifier. Conventional networks are typically identified by a nominal identifier, such as a network name or workgroup name. This nominal identifier is communicated to the network interface adapter, at 322, when the network interface adapter first contacts the network. In an 802.11b network, for example, the SSID is typically included in the network beacon signal that is periodically broadcast. These nominal network identifiers are rarely unique, because often such identifiers are a default name that is assigned to the network when the network is first established. To further distinguish each network, the IP address of a device on the network is determined, at 324, and the MAC address of the access device is determined, at 326. The MAC-address is determined by examining the Management Information Base (MIB) information that can be requested from the network. The MAC address is a six-byte value that identifies, in the upper three bytes, the manufacturer of the access device. The manufacturer assigns a unique identifier to each access device, using the lower three bytes. In an ad-hoc network, which does not include an access device, an identifier that is associated with one of the other devices in the network is used in lieu of the MAC address of the access device. At 328, the nominal network identifier, the IP-address, and the MAC address are combined to provide a network identifier that is substantially unique. In a straightforward embodiment, a simple concatenation of these parameters provides the unique network identifier. Optionally, to reduce the storage requirement for each of these unique identifiers, a hashing function may be used to combine these parameters, using techniques common in the art.

The foregoing merely illustrates the principles of the invention. It will thus be appreciated that those skilled in the art will be able to devise various arrangements which, although not explicitly described or shown herein, embody the principles of the invention and are thus within its spirit and scope. For example, different techniques may be employed to create a unique network identifier, and different techniques may be used to determine whether to automatically configure the system based on ‘partial’ matches of the unique identifiers. For example, the system may be designed to retrieve the stored configuration data, at 360 in FIG. 3, whenever both the SSID and MAC addresses of the unique identifiers match, and only requires the match of the IP-address component when a MAC address is not available. In like manner, the user can be provided options regarding the required degree of matching for different network identifiers. These and other system configuration and optimization features will be evident to one of ordinary skill in the art in view of this disclosure, and are included within the scope of the following claims.

I claim:

1. A processing system comprising:
a processing device that is capable of sending and receiving data to and from each of a plurality of networks,
a network interface device, operably coupled to the processing device, that provides communication of the data to and from a select network of the plurality of networks, based on a select set of configuration data associated with the select network, and
a network configuration device, operably coupled to the network interface device, that stores the select set of configuration data for subsequent retrieval;
wherein
the network interface device further provides a notification to the network configuration device when the processing system is subsequently reconnected to the select network, and
the network configuration device, in response to the notification, retrieves the select set of configuration data to facilitate a reconfiguration of the network interface device for subsequent communications to and from the select network,

2. The processing system of claim 1, wherein
the network configuration device further
stores a plurality of sets of configuration data, corresponding to the plurality of networks, the select set of configuration data being included in the plurality of sets of configuration data, and
indexes each set of configuration data of the plurality of sets of configuration data, based on a substantially unique identifier of each network of the plurality of networks.

3. The processing system of claim 2, wherein
the substantially unique identifier of each network is based on an identifier of the network and an identifier of an access device that couples the network interface device to the network.

4. The processing system of claim 3, wherein
the identifier of the access device includes a MAC-address that is associated with the access device.

5. The processing system of claim 2, wherein
the substantially unique identifier includes an IP-address that is associated with the select network.

6. A network configuration device comprising:
a network identifier that creates a substantially unique identification of a network based on an identification of the network and an identification of an access device associated with the network,
a memory that stores configuration data corresponding to the unique identification of the network, and
a configurer that retrieves the configuration data from the memory, based on the substantially unique identification of the network, to facilitate a reconfiguration of a network interface device for subsequent communications to and from the network.

7. The network configuration device of claim 6, wherein
the network identifier further creates other substantially unique identifications of other networks,
the memory further stores other configuration data corresponding to the other substantially unique identifications, and
the configurer further retrieves select configuration data of the other configuration data, based on the substantially unique identification of a select network of the other networks, to facilitate a subsequent reconfiguration of the network interface device for communications to and from the select network.

8. The network configuration device of claim 7, wherein
the substantially unique identification of the select network is based on an identifier of the select network and an identifier of an access device that couples the network interface device to the select network.

9. The network configuration device of claim 8, wherein
the identifier of the access device includes a MAC-address that is associated with the access device.

10. The network configuration device of claim 6, wherein
the substantially unique identification includes an IP-address that is associated with the select network.

11. A method of providing configuration data for configuring a network interface device, comprising:
creating a set of configuration data corresponding to each network of a plurality of networks when the network interface device is first configured to communicate with the network,
storing the set of configuration data corresponding to each network,
detecting when the network interface device is able to be reconnected to a select network of the plurality of networks, and
retrieving the set of configuration data corresponding to the select network for configuring the network interface device to communicate with the select network.

12. The method of claim 11, further including
creating a substantially unique identifier of each network of the plurality of networks, and wherein
the storing and retrieving of each set of configuration data is based on the substantially unique identifier of each network.

13. The method of claim 12, wherein
the substantially unique identifier of each network is based on an identifier of the network and an identifier of an access device that couples the network interface device to the network.

14. The method of claim 13, wherein
the identifier of the access device includes a MAC-address that is associated with the access device.

15. The method of claim 12, wherein
the substantially unique identifier of each network is based on an IP address that is associated with the network.

16. The method of claim 11, further including
receiving a user selection that identifies the select network.
